(19) United States
(12) Patent Application Publication
(10) Pub. No.: US 2007/0278162 A1
(43) Pub. Date: Dec. 6, 2007

(54) Method Of, And Apparatus For,Treating, Filtering And Cleaning A Working Medium

(76) Inventor: Zbigniew Combrowski, Tuttlingen (DE)

Correspondence Address: BACHMAN & LAPOINTE, P.C., 900 CHAPEL STREET, SUITE 1201, NEW HAVEN, CT, 06510, US

(21) Appl. No.: 10/593,843

(22) PCT Filed: Mar. 18, 2005
(86) PCT No.: PCT/EP05/02926

§ 371 Date: Jul. 19, 2007

(30) Foreign Application Priority Data
Mar. 22, 2004 (DE) 102004014332.3
Oct. 26, 2004 (DE) 102004052098.4

(51) Int. Cl. B01D 29/62; B01D 25/32; B01D 37/00

(52) U.S. Cl. 210/770; 210/798; 210/407

(57) ABSTRACT

A method is provided for attending to, filtrating and cleaning a working medium using at least one filter in a filter housing which adjoins a discharge device for a filter cake. The filtered out particles are gradually compacted in the discharge device to give the filter cake. The compacted filter cake is discharged once it has reached a predetermined thickness.

### BACKGROUND OF THE INVENTION

1. Field of the Invention

The invention relates to a method of treating, filtering and cleaning a working medium, having at least one filter in a filter housing which is adjoined by a discharging arrangement for discharging a filter cake, and also relates to an apparatus therefor and to a discharging arrangement.

2. Prior Art

Working medium which is to be cleaned is to be understood as all conceivable media from the industrial and/or private sectors which are to be freed of particulate contamination. These media include, in particular, cooling lubricants, oil, grinding water, washing baths and washing water for motor vehicles, and water used in the pharmaceutical and chemical industries and in food production. However, these are only examples.

An apparatus of the type mentioned above is known from DE 101 40 709 A1. In this document, the working medium is fed at least to one filter via at least one line, the filter forming at least one filter surface which has the working medium flowing through it. Thereafter, the filtrate passes to a filtrate outlet, while the filtered-out particles are moved to a sedimentation chamber. There, the filtered-out particles sink downward, cake together and are then removed by way of a valve, a slide or a pneumatic, mechanical or hydraulic flap or shutter. It is also conceivable for them to be pushed out by a discharging piston.

### SUMMARY OF THE INVENTION

The problem on which the present invention is based is that of providing a method and an apparatus of the above-mentioned type, in the case of which the operation of discharging the filter cake is significantly improved.

This problem is addressed firstly in that the filtered-out particles are compacted in stages in the discharging arrangement to form the filter cake and the compacted filter cake is discharged once a predetermined thickness has been reached.

This means that the filter cake is compacted to significantly-better effect and passes out of the discharging arrangement in a virtually dry state. On the one hand, it is thus easier to dispose of and, on the other hand, working medium is forced out of it as far as possible and can pass back into the working process again. It is therefore possible to cut back on the amount of working medium used.

The operation of the pressing piston is preferably controlled by way of its stroke and its pressure. A relatively low pressure is selected initially, so that the filtered-out particles are easily compressed. Once the filter cake has reached a certain thickness, the pressure can be constantly increased. In many cases, however, it is sufficient to increase the pressure to the end of the operating cycle. This ensures that the filter cake contains as little liquid as possible.

The stroke of the pressing piston is monitored at the same time, the thickness of the filter cake being determined as a result. This takes place via distance-measuring sensors of any desired construction. As soon as the filter cake has reached a prescribed thickness, the pressure of the pressing piston is increased and/or the filter cake is ejected.

The operation of forcing filtrate out of the filter cake back into a feed hopper has the advantage that there is constant movement in the feed hopper, so that there is no caking together there of particles which are to be discharged, and possibly block the feed hopper.

A further method according to the invention also relates to the last-mentioned feature and although protection is sought independently for it, the intention is for it to be used in particular in conjunction with the method which has just been described. According to this method, the intention is for the medium to be caused to move, in particular vortexed, just before and/or during transfer between the filter housing and discharging arrangement. This means that, in this region, there is no bridge formation of particles which would block the hopper.

In the case of a further method according to the invention, for which protection is likewise independently sought, it is possible for the filter housing to be subjected to pressure for the purpose of discharging the filter cake and/or for the filter cake to be extracted from the discharging arrangement by suction. There is no need here for the filter cake to be subjected to any pressing action. The only important factor is a quick discharging operation, i.e. the filter housing is emptied quickly. This is ensured by the positive pressure generated and/or by the suction extraction.

It is preferable for the filter to be back-flushed at certain time intervals. A number of possibilities are conceivable here. First of all, the interior of the filter should be subjected to the action of a medium, so that the sludge located on the outside of the filter is lifted off from the filter surface. This can take place, for example, using compressed air or else also by means of a filter pump which subjects the filter to the action of a medium, in particular filtrate, from the inside out. The filter surface is subsequently, or simultaneously, subjected to the action of a further medium, for example this may be the working medium which is to be cleaned itself. It is also conceivable here to provide flushing nozzles, which are used to flush the filter, the filter space, the feed hopper and also the discharging arrangement.

Protection is claimed specifically for a preferred back-flushing operation which contains another method of particle removal. For this purpose, the feed pump of the filter for the working medium is switched off prior to the back-flushing operation in order to render the interior housing of the filter pressureless. In order that it is possible for effective back-flushing to be carried out and for the particles to be transported away to better effect, the housing has to be emptied quickly. For this purpose, a back-flushing pulse is preferably initiated and/or a valve on the installation housing is opened in order thus to accelerate the outflow of the medium in the filter via the filter pump or a separate valve.

In the case of a corresponding apparatus, an antechamber is to be separated from a pressing chamber in the discharging arrangement. A corresponding pressing piston, in the first instance, passes through the antechamber and pushes the sedimented particles into the pressing chamber. There, the particles are compressed and compacted to form the filter cake.

The pressing chamber is closed by a slide. This slide can be opened if required, if, for example, the filter cake has reached a predetermined thickness. The drive for the slide and the slide itself are commercially available, and so a more detailed description can be omitted.

The pressing piston is preferably part of a piston/cylinder unit which can be operated pneumatically or hydraulically. It is configured in such a manner that it can pass through the antechamber and pressing chamber. In terms of cross section, it is appropriate for it to be of cylindrical design, but other cross sections are also conceivable and are to be covered by the invention.

The piston or at least its lateral surface consists of plastic, which has the advantage that, for example, chips can be incorporated into the plastic casing without it becoming welded to the chamber.

Otherwise, the pressing piston and its sealing are configured in such a manner that ejected filtrate can pass back into the feed hopper again.

The above-mentioned vortexing of the medium in the feed hopper toward the discharging arrangement is brought about, with regard to simplicity, by it being possible for working medium which is to be inserted to penetrate the hopper through corresponding passages. For this purpose, corresponding passages can be molded into a hopper wall, but, for the sake of simplicity, a hopper wall or an impact wall inserted into the hopper is to be at a distance from a side wall, so that working medium can penetrate the hopper through the resultant slot where it can generate a vortex.

It is similarly possible to provide the filter, the filter space, the feed hopper and the discharging arrangement with nozzles in the interior or exterior of the filter housing and therefore to optimize the transporting away of the filter cake to the discharging arrangement and the simultaneous flushing of the above-mentioned regions.

The discharging arrangement described above forms an independent structural element which can also be fitted to other filter devices or the like. Separate protection is therefore also sought for this element.

It is likewise possible to operate this system in a low-cost variant, without the above-mentioned discharging arrangement (containing pressing piston and pressing chamber) which is just provided with a valve, a slide or a pneumatic, mechanical or hydraulic flap or shutter.

The slide can furthermore also serve to securely separate the compacted sludge, i.e. the briquette, from the piston, so that it is not drawn back into the pressing space when the piston is retraced. In this case, the slide pushes the briquette away from the piston, so that it drops down.

### BRIEF DESCRIPTION OF THE DRAWINGS

Further advantages, features and details of the invention emerge from the description below of preferred exemplary embodiments and with reference to the drawing, in which

FIG. 1 shows a cross section through an apparatus according to the invention for treating and cleaning a working medium;

FIG. 2 shows a plan view of a discharging arrangement according to the invention;

FIG. 3 shows the discharging arrangement according to FIG. 2 in a view which is illustrated in reduced form and perspectively;

FIG. 4 shows a cross section through the discharging arrangement according to FIG. 2 along line IV-IV.

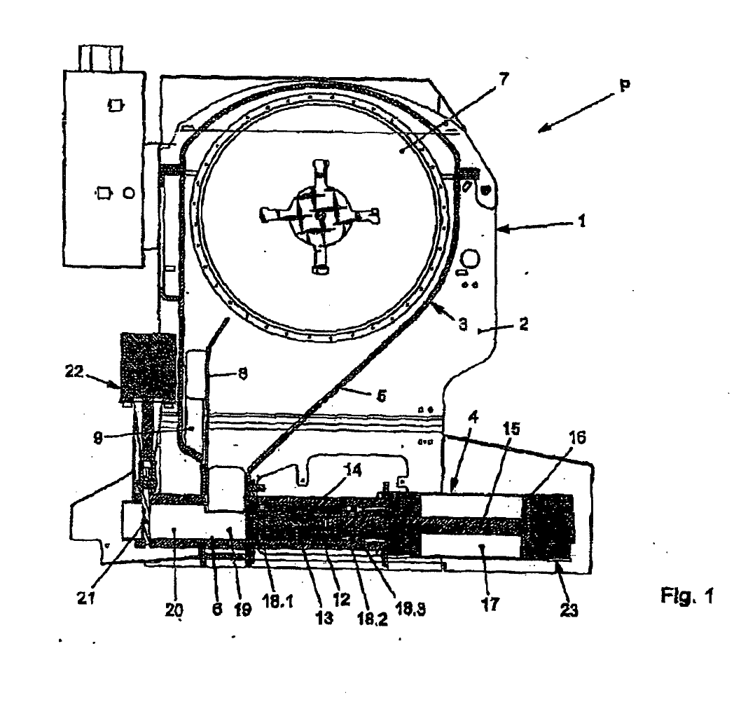

### DETAILED DESCRIPTION OF THE PREFERRED EMBODIMENT(S)

An apparatus P according to the invention for treating and cleaning a working medium has a preferably closed filter housing 1. A filter housing 1 of this type is described, for example, in DE 101 40 709, to which, in particular, reference is made. Accordingly, only the parts essential to the present invention are described in more detail below.

The filter housing 1 comprises two side walls, of which only the rear wall 2 is shown, and a housing casing 3, which is inserted between the two side walls. Downward toward a discharging arrangement 4, the housing casing 3 forms a hopper 5 through which filtered-out particles can pass to a discharging chamber 6 of the discharging arrangement 4.

Filter surfaces 7 serving to filter out particles from the working medium to be cleaned are situated in the housing casing 3. In the present exemplary embodiment, the working medium which is to be cleaned is introduced from below behind an impact wall 8 in the hopper 5. A corresponding inlet 9 is merely indicated.

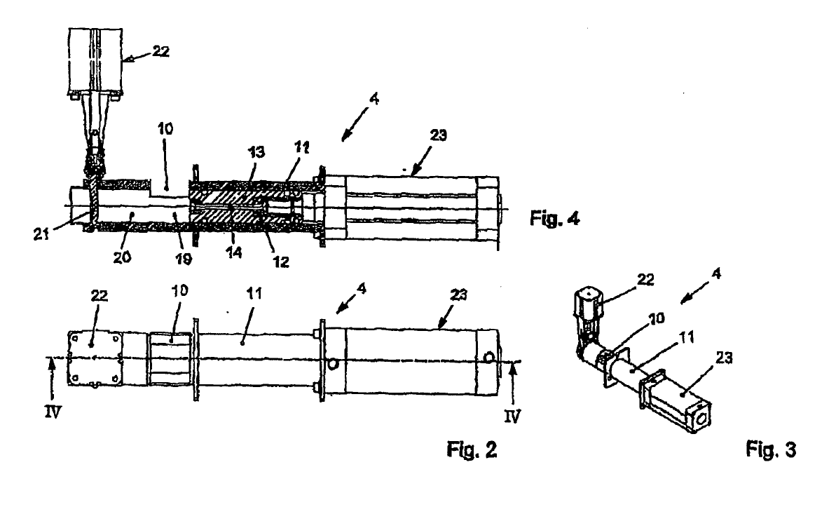

The discharging arrangement 4 directly adjoins the hopper 5 by means of an opening 10 (see FIGS. 2 to 4). In this case, the opening 10 is cut into a pipe 11. The discharging chamber 6 and a cylinder space 12 for receiving a pressing piston 13 are situated in the pipe 11. The pressing piston 13 preferably consists of plastic and is connected to a piston rod 15 via a threaded bolt 14. This piston rod 15 moves in a pressure space 17 of a corresponding piston/cylinder unit 23 under the pressure exerted by a pressure-exerting piston 16.

The pressing piston 13 is sealed off with respect to the cylinder space 12 by an annular seal 18.1 at the front end and by two annular seals 18.2 and 18.3 at the rear end. The annular seal 18.1 is configured in such a manner that it lets liquid through. However, the annular seal 18.1 is not required for every application.

The discharging chamber 6 is divided into an antechamber 19, which directly adjoins the hopper 5, and a pressing chamber 20, which adjoins the antechamber 19 approximately horizontally. The pressing chamber 20 is closed by a slide 21 which can be moved by a corresponding drive 22.

The manner of operation of the present invention is as follows:

Working medium to be cleaned flows via the inlet 9 into the filter housing 1 where it is conducted by the impact wall 8 toward the filter surface 7. However, according to the invention, the intention is for it also to be possible for a relatively small part of the working medium to flow into the hopper 5, which is possible by the fact that the impact wall 8 maintains a distance, for example, from the rear wall 2 (not shown specifically), so that a slot is produced between impact wall 8 and rear wall 2.

This working medium flowing into the hopper 5 has the advantage that it generates vortexes there, so that the particles dropping into the hopper 5 or settling at the bottom thereof cannot bind together and also not produce any bridges which lead to a blockage of the hopper 5.

The particles separated from the working medium by the filter surface 7 drop downward in the hopper 5 and fall into the antechamber 19 of the discharging chamber 6. From time to time, the pressing piston 13 is caused to move by means of the piston/cylinder unit 23, it passing through the antechamber 19 and transporting the particles out of the antechamber 19 into the pressing chamber 20. It compresses the particles there at a pressure of, for example, 15 bar to 100 bar. The ejected filtrate flows along the gap between pressing piston 13 and inner wall of the pressing chamber 20 via the annular seal 18.1 to the rear into the antechamber 19 and is forced upward there into the hopper 5. This also results, in the transition from hopper 5 to antechamber 19, in a flow which opposes a bridge formation of the settling particles.

As the pressing piston 13 passes from antechamber 19 to pressing chamber 20, for example chips from the casing of the pressing piston may be carried along in the edge region. Since the casing of the pressing piston consists of plastic, the chips are pressed into the plastic, so that the pressing piston does not stick in the pressing chamber 20. At the same time, the chips also produce scores in the plastic casing of the pressing piston, via which a recycling of the filtrate from the pressing chamber 20 is facilitated. No cold welding as in the case of conventional metal pistons takes place.

The operation of the pressing piston 13 gives rise, in the pressing chamber 20, to a filter cake briquette which is very compacted. This reduces the extension travel of the pressing piston over the course of time. This extension travel and the pressure applied by the pressing piston are monitored by a control means (not shown specifically). If, for example, the pressing piston no longer reaches a certain distance measurement sensor, this means that a filter cake of appropriate thickness has been achieved. During the next stroke operation of the pressing piston, a further, very strong compaction of the filter cake is therefore to take place, for which purpose, for example, the working pressure of the pressing piston is increased to 50 bar. After this working stroke, the slide 21 is opened by means of the drive 22 and the filter cake can be ejected from the pressing chamber 20 by the pressing piston 13.

If it should be necessary to exchange the pressing piston 13, this likewise takes place in a very simple manner. With the slide 21 open, the pressing piston 13 is extended as far as possible. This makes the threaded bolt 14 accessible, so that it can be acted upon by a corresponding tool and can be released. In place of the threaded bolt 14, a corresponding pulling-out tool is now screwed into the front end of the pressing piston 13, so that the pressing piston 13 can be pulled out of the discharging chamber 6.

According to the present invention, discharging arrangement 4 and inlet 9 for the working medium to be cleaned are situated at the lowermost point of the filter housing 1. If the latter is emptied after the end of the filtering cycle, a negative pressure is produced in the filter housing 2, as a result of which the filter surface 7 is washed over. The corresponding sludge components drop downward into the hopper 5 and from there into the discharging chamber 6. This improves the cleaning of the filter surface 7.

At the beginning of the filtering cycle, the inlet 9 is preferably oriented in such a manner that a jet of working medium to be cleaned impacts directly on the filter surface 7. This jet thereby likewise sprays the filter surfaces 7 such that they are clean, and the sludge flows through the hopper 5 into the discharging chamber 6.

1-17. (canceled)

18. A method of treating, filtering and cleaning a working medium comprising the steps of providing at least one filter in a filter housing which is adjoined by a discharging arrangement for discharging a filter cake, compacting filtered-out particles in stages in the discharging arrangement to form the filter cake, discharging the compacted filter cake once a predetermined thickness has been reached, back-flushing the at least one filter at certain time intervals, with air or some other pressure medium being introduced into an interior of the at least one filter, and externally subjecting the at least one filter to the action of the working medium or some other flushing medium during the back-flushing operation.

19. A method of treating, filtering and cleaning a working medium, comprising the steps of providing at least one filter in a filter housing which is adjoined by a discharging arrangement for discharging a filter cake, compacting filtered-out particles in stages in the discharging arrangement to form the filter cake, discharging the compacted filter cake once a of a pressing piston is determined, and increasing the pressure of the pressing piston during a final pressing stage.

20. The method as claimed in claim 18, further comprising using a back-flushing pulse for discharging the filter cake.

21. The method as claimed in one of claim 18, further comprising subjecting the at least one filter to the action of the flushing medium via flushing nozzles which are oriented in the direction of the at least one filter.

22. The method as claimed in claim 18, further comprising determining the thickness of the cake via a distance measurement when a certain thickness of a briquette of a pressing piston has been reached.

23. The method as claimed in claim 18, further comprising causing the flushing medium to move, in a vortex, just before and/or during transfer between the filter housing and the discharging arrangement.

24. The method as claimed in claim 18, further comprising forcing the out of the filter cake back into a feed hopper.

25. The method as claimed in claim 18, further comprising subjecting the filter housing to pressure for the purpose of discharging the filter cake.

26. The method as claimed in claim 18, further comprising extracting the filter cake from the discharging arrangement by

27. An apparatus for treating, filtering, and cleaning a working medium comprising at least one filter, in a filter housing adjoining a discharge arrangement for discharging a filter cake once a predetermined thickness has been reached, said at least one filter being periodically back-flushed, from the filter housing, the hopper opens out downwards into an antechamber of the discharging arrangement, which is adjoined by a pressing chamber, the antechamber and the pressing chamber being assigned a pressing piston.

28. The apparatus as claimed in claim 27, wherein the pressing chamber is closed by a slide.

29. The apparatus as claimed in claim 27, wherein the pressing piston is assigned at least one sensor for determining the position of the pressing piston.

30. The apparatus as claimed in one of claim 27, wherein the pressing piston is connected to a piston rod via a threaded bolt, which is inserted into the pressing piston from an end side.

31. The apparatus as claimed in claim 27, wherein at least a lateral surface of the pressing piston consists, at least in part, of plastic.

32. The apparatus as claimed in claim 27, wherein a wall of the hopper has at least one aperture for the through-passage

33. The apparatus as claimed in claim 27, wherein the hopper has at least one aperture for the through-passage of a liquid into the hopper.

34. The apparatus as claimed in claim 32, wherein the wall maintains a distance, at least in part, from a side wall of the filter housing.

35. The apparatus as claimed in claim 27, wherein a wall of the hopper forms at least one aperture, and the working medium which flows into the filter housing and is to be cleaned being able to flow against the aperture-forming wall.

36. A discharging arrangement for discharging a filter cake, comprising a pressing chamber arranged downstream of an antechamber for accommodating filtered-out particles, the passing chamber and the antechamber being assigned a pressing piston-and the course of the pressing piston being monitored by sensors and the pressing chamber being closed by a slide.
